(19) United States
(12) Patent Application Publication
(10) Pub. No.: US 2014/0294436 A1
(43) Pub. Date: Oct. 2, 2014

(54) IMAGE FORMING APPARATUS

(71) Applicant: SHARP KABUSHIKI KAISHA, OSAKA (JP)

(72) Inventors: Yasuyuki ISHIGURO, Osaka (JP); Takeshi OKUDA, Osaka (JP); Hiroshi KUBOTA, Osaka (JP); Hisashi KUNIHIRO, Osaka (JP); Eiji TENJIKU, Osaka (JP); Hitoshi NAGAHAMA, Osaka (JP)

(73) Assignee: SHARP KABUSHIKI KAISHA, OSAKA (JP)

(21) Appl. No.: 14/221,493

(22) Filed: Mar. 21, 2014

(30) Foreign Application Priority Data
Mar. 27, 2013 (JP) 2013-067604

(51) Int. Cl. G03G 15/00; G03G 21/12; G03G 15/08

(52) U.S. Cl. CPC G03G 21/12
USPC 399/107; 399/360; 399/258

(57) ABSTRACT

In an image forming apparatus, a fixing drive motor is positioned inside the image forming apparatus and closely to the front surface of the image forming apparatus so as to be laterally to toner cartridges and a waste toner box in a direction parallel to an outer surface of a front housing section.

This Nonprovisional application claims priority under 35 U.S.C. §119 on Patent Application No. 2013-067604 filed in Japan on Mar. 27, 2013, the entire contents of which are hereby incorporated by reference.

### TECHNICAL FIELD

The present invention relates to an image forming apparatus which includes a toner cartridge and forms a visible image with toner supplied from the toner cartridge.

### BACKGROUND ART

An electrophotographic image-forming device forms an electrostatic latent image in accordance with an image to be printed, and visualizes the electrostatic latent image. Specifically, the electrophotographic image-forming device includes a photoreceptor and a developing device so as to form an electrostatic latent image on the photoreceptor and to develop, namely, visualize the electrostatic latent image with toner supplied from the developing device. Note that a toner image thus formed on a surface of the photoreceptor by the development of the electrostatic latent image is transferred onto, for example, a transfer belt, and from which the image is transferred onto a sheet. Then, the electrostatic latent image is fixed on the sheet by a fixing device. The fixing device is driven by a fixing drive motor.

In the image forming apparatus, in a case where the toner of the developing device is consumed as a result of the development, the developing device is supplied with toner from the toner cartridge as appropriate. Waste toner, which is remainder of toner supplied from the toner cartridge and used in the image forming apparatus, is collected and stored in a waste toner box.

Further, the toner cartridge is replaced with a new toner cartridge when the toner cartridge becomes empty. The waste toner box is replaced with an empty one when the waste toner box becomes filled up.

According to a configuration of an image forming apparatus disclosed in Patent Literature 1, a toner cartridge includes a supply toner tank, a waste toner box, a discharge-side shutter, an inflow-side shutter, a case cover, and the like. This toner cartridge is attached to a process cartridge, is located above a developing unit, and supplies the developing unit with toner stored in the supply toner tank. The waste toner box stores waste toner collected by a photoreceptor cleaning unit. The toner cartridge is replaced with a new toner cartridge when the toner stored in the supply toner tank is finished or when the waste toner stored in the waste toner box becomes excessive in amount.

According to a configuration of an image forming apparatus disclosed in Patent Literature 2, there is provided a cartridge supporting member capable of switching its posture between a frame standing posture and an inclined posture. The cartridge supporting member is designed to allow a toner cartridge to be inserted thereto or detached therefrom when having the inclined posture by rotation in one direction around a predetermined supporting point, and to mount the toner cartridge on a developing device when having the standing posture by rotation in the other direction around the supporting point.

According to a configuration of an image forming apparatus disclosed in Patent Literature 3, toner cartridges are arranged near a front surface of the image forming apparatus and in parallel to a rotation direction of an intermediate transfer member, and a toner cartridge cover is openably provided so as to cover all the toner cartridges. Further, an image reading section is disposed above the image forming apparatus in such a manner that the image reading section does not cover the toner cartridges. With this, the toner cartridge, which is frequently replaced, can be attached or detached without taking away the image reading section. Further, even in a case where a single function printer (SFP) is modified into a multifunction printer (MFP), it is possible to handle the toner cartridges in the same manner also in the MFP. Thus, the MFP can keep substantially the same operability regarding attachment/detachment of the toner cartridges as that of SFP.

### CITATION LIST

### Patent Literatures

Patent Literature 1
Japanese Patent Application Publication, Tokukai, No. 2008-233548 A (Publication Date: Oct. 2, 2008)

Patent Literature 2
Japanese Patent Application Publication, Tokukai, No. 2007-65271 A (Publication Date: Mar. 15, 2007)

Patent Literature 3
Japanese Patent Application Publication, Tokukai, No. 2009-181023 A (Publication Date: Aug. 13, 2009)

### SUMMARY OF INVENTION

### Technical Problem

There has always been a demand for downsizing an image forming apparatus, i.e. reducing an area occupied by the image forming apparatus. Such a demand is particularly notable for an image forming apparatus used in a small office or a home office. As for downsizing an image forming apparatus, i.e. reducing an area occupied by the image forming apparatus, effective use of a space in the image forming apparatus is to be mainly considered. In a configuration including a toner cartridge, a waste toner box, and a fixing drive motor, relative positions thereof greatly influence the downsizing.

However, none of Patent Literatures 1 to 3 takes relative positions of a toner cartridge, a waste toner box, and a fixing drive motor into consideration for the purpose of downsizing an image forming apparatus.

Therefore, an object of the present invention is to provide an image forming apparatus which is downsized and occupies a smaller area as a result of appropriately setting relative positions of a toner cartridge, a waste toner box, and a fixing drive motor.

### Solution to Problem

In order to solve the foregoing problem, an image forming apparatus in accordance with one aspect of the present invention is an image forming apparatus, including: a toner cartridge; a waste toner box for containing waste toner after the waste toner is connected, the waste toner being remainder of toner supplied from the toner cartridge and used in the image forming apparatus; and a fixing drive motor for driving a fixing device, the toner cartridge and the waste toner box being positioned between (i) a front frame or a front inside cover of the image forming apparatus and (ii) a front housing section of the image forming apparatus, the front frame being a front side frame inside the image forming apparatus, and the front inside cover being positioned between the front frame and the front housing section, and the fixing drive motor being positioned in a front side part of an inside of the image forming apparatus and closely to the front surface of the image forming apparatus and being positioned laterally to the toner cartridge and the waste toner box in a direction parallel to an outer surface of the front housing section.

### Advantageous Effects of Invention

With the one aspect of the present invention, it is possible to appropriately set relative positions of the toner cartridge, the waste toner box, and the fixing drive motor, thereby downsizing the image forming apparatus and reducing an area occupied by the image forming apparatus.

### BRIEF DESCRIPTION OF DRAWINGS

FIG. 1 is a perspective view of an image forming apparatus of an embodiment of the present invention.

FIG. 2 is a perspective view of the image forming apparatus with a front door illustrated in FIG. 1 being opened.

FIG. 3 is an elevational view of the image forming apparatus with the front door illustrated in FIG. 1 being opened.

FIG. 4 is a perspective view of developing devices included in the image forming apparatus illustrated in FIG. 1.

FIG. 5 is an elevational view illustrating an inner configuration of the image forming apparatus illustrated in FIG. 1.

FIG. 6 is a perspective view of a toner cartridge shown in FIG. 3.

FIG. 7 is a plan view of the toner cartridge shown in FIG. 6.

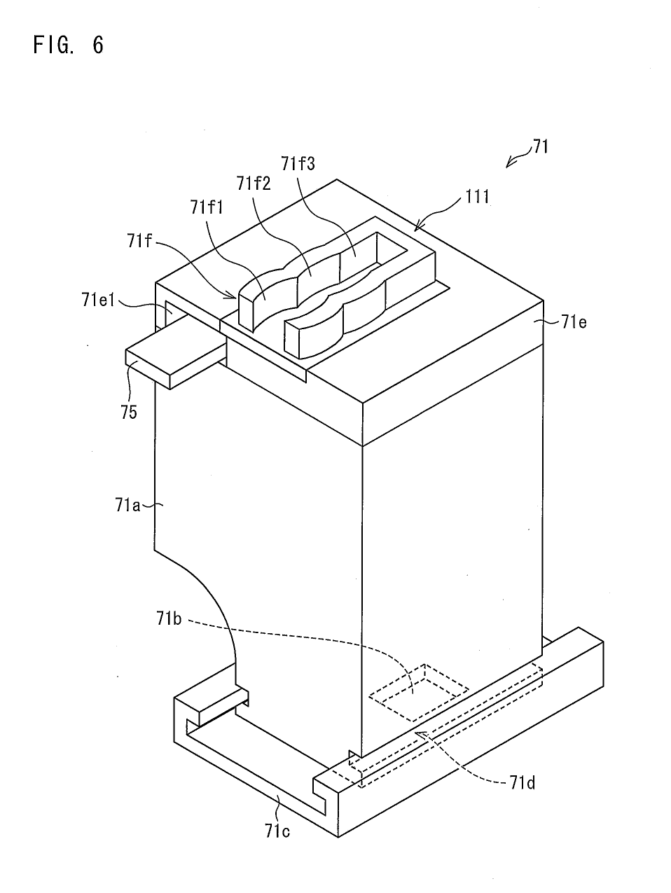

(a) of FIG. 8 illustrates a side view of the toner cartridge and a longitudinal section view of a shutter of the toner cartridge illustrated in FIG. 6 being closed. (b) of FIG. 8 illustrates a side view of the toner cartridge and a longitudinal section view of the shutter illustrated in (a) of FIG. 8 being opened. (c) of FIG. 8 is a plan view illustrating a spring connecting section of a toner storing section shown in (a) of FIG. 8. (d) of FIG. 8 is an elevational view illustrating another spring connecting section of the shutter illustrated in (a) of FIG. 8.

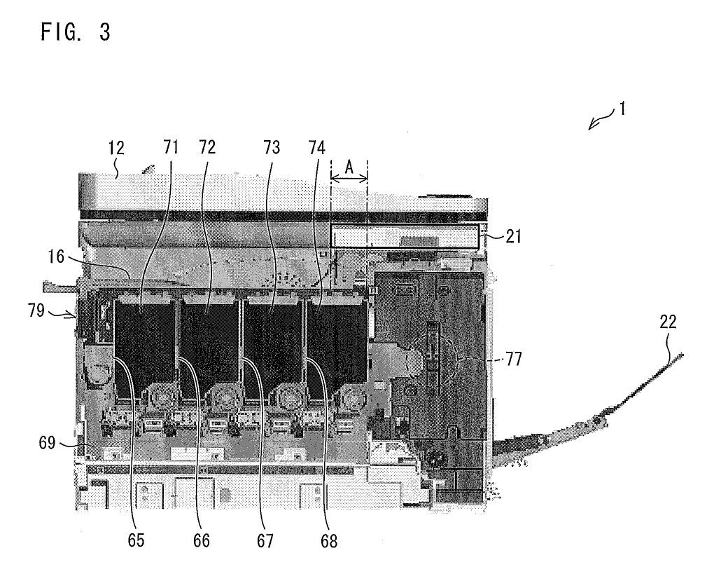

(a) of FIG. 9 is a longitudinal section view of a back wall of the toner cartridge illustrated in FIG. 3. (b) of FIG. 9 is a view showing how to handle the toner cartridge with use of a recess on the back wall.

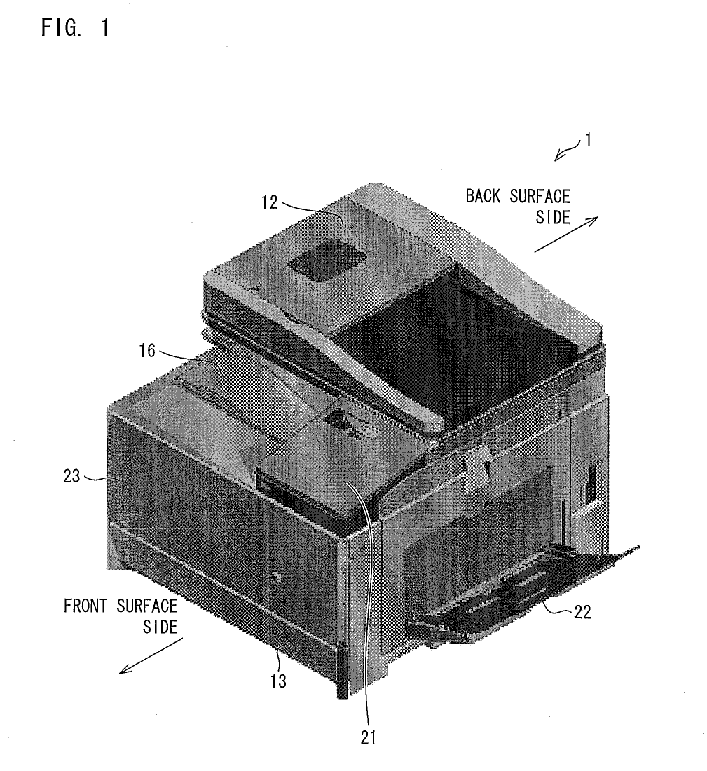

FIG. 10 is an elevational view schematically illustrating a configuration of a cartridge attaching section of the image forming apparatus illustrated in FIG. 1 and a part around the cartridge attaching section.

(a) of FIG. 11 is an elevational view of the cartridge attaching section illustrated in FIG. 10. (b) of FIG. 11 is a view illustrating the toner cartridge and the developing device illustrated in (a) of FIG. 11.

FIG. 12 shows longitudinal cross section views respectively illustrating (i) a state in which the toner cartridge is not attached to the cartridge attaching section and (ii) a state in which the toner cartridge is attached to the cartridge attaching section illustrated in FIG. 11.

FIG. 13 is an elevational view illustrating relative positions of a toner cartridge, a waste toner box, an operation panel, a fixing section, and a fixing drive motor in the image forming apparatus illustrated in FIG. 1.

FIG. 14 is a longitudinal section view of the image forming apparatus illustrated in FIG. 13 seen from a side thereof.

FIG. 15 is an elevational view illustrating another example of the image forming apparatus illustrated in FIG. 13.

### DESCRIPTION OF EMBODIMENTS

(Overall Configuration of Image Forming Device)

The following will describe an embodiment of the present invention with reference to the drawings. FIG. 1 is a perspective view illustrating an image forming apparatus 1 of the embodiment of the present invention. The image forming apparatus 1 is a full color printer in the present embodiment. Therefore, the image forming apparatus 1 is configured to print a color image on a sheet (a recording medium in the form of sheet) in accordance with image data externally supplied. Note here that the present embodiment describes an example where the image forming apparatus 1 is a printer. Alternatively, the image forming apparatus may be a copy machine, a fax machine, or a multifunction peripheral having functions of these machines. In this case, the image forming apparatus 1 prints on a sheet a multicolor image or a single color image in accordance with image data externally supplied and/or image data which is read from a document by a scanner. Note that the image forming apparatus 1 may be a monochrome printer.

The image forming apparatus 1 includes an automatic document feeder 12 in a region of a top surface of the image forming apparatus 1, the region being close to a back surface of the image forming apparatus 1 (see FIG. 1). The image forming apparatus 1 includes a housing and a paper output tray 16 which is provided in a region of an upper surface of the housing, the region being closer to a front surface of the image forming apparatus 1 than the automatic document feeder 12 is. The image forming apparatus 1 includes an operation panel 21 on the right side (when facing the front surface of the image forming apparatus 1) of the paper output tray 16. The operation panel 21 includes a display device. Further, the image forming apparatus 1 includes a paper feeding cassette 13 which is provided at a bottom of the image forming apparatus 1 and which can be pulled forward, and a foldable manual paper feeding tray 22 which is provided on the right side (when facing the front surface of the image forming apparatus 1) of the image forming apparatus 1. Moreover, the image forming apparatus 1 includes a front door (front housing section) 23 on the front surface and above the paper feeding cassette 13. The front door 23 can be vertically opened and closed around its lower end which serves as a rotational axis.

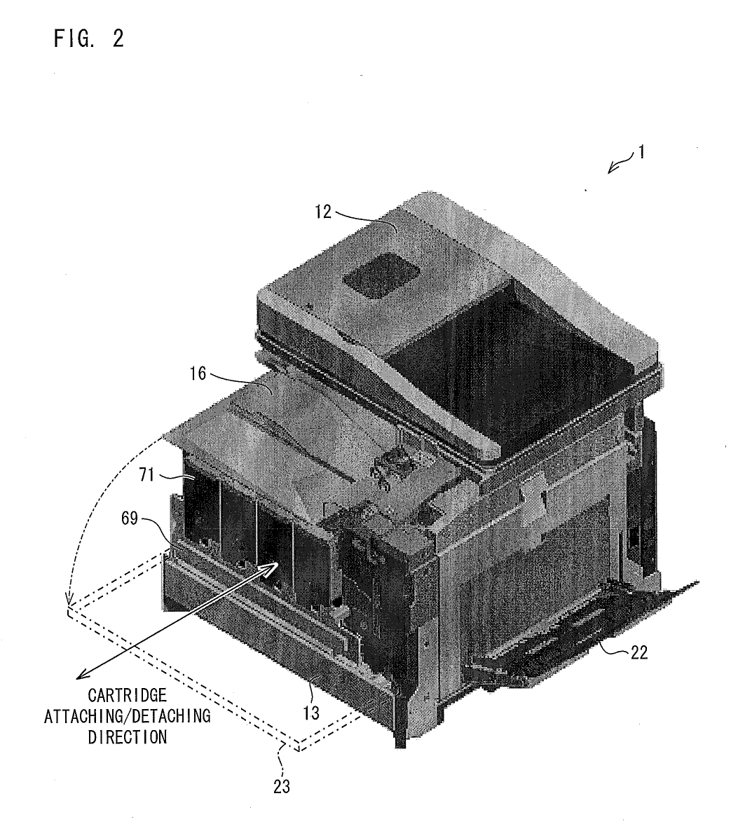

The image forming apparatus 1 includes, in its inner part that is exposed when the front door 23 is opened, toner cartridges 71 to 74 and a waste toner box 69 so that the toner cartridges 71 to 74 are positioned above the waste toner box 69 (see FIGS. 2 and 3). FIG. 2 is a perspective view of the image forming apparatus with the front door 23 shown in FIG. 1 being opened. FIG. 3 is an elevational view of the image forming apparatus 1 with the front door 23 shown in FIG. 1 being opened.

The toner cartridges 71 to 74 are disposed so as to be close to the front surface and are aligned at the same height in a lateral direction of the image forming apparatus 1 (see FIGS. 2 and 3). These toner cartridges 71 to 74 are respectively attached to cartridge attaching sections 65 to 68 formed on a front inside cover 79 of the image forming apparatus 1, which front inside cover 79 is made from, for example, an ABS resin. In the present embodiment, the toner cartridges 71 to 74 store yellow toner, magenta toner, cyan toner, and black toner, respectively.

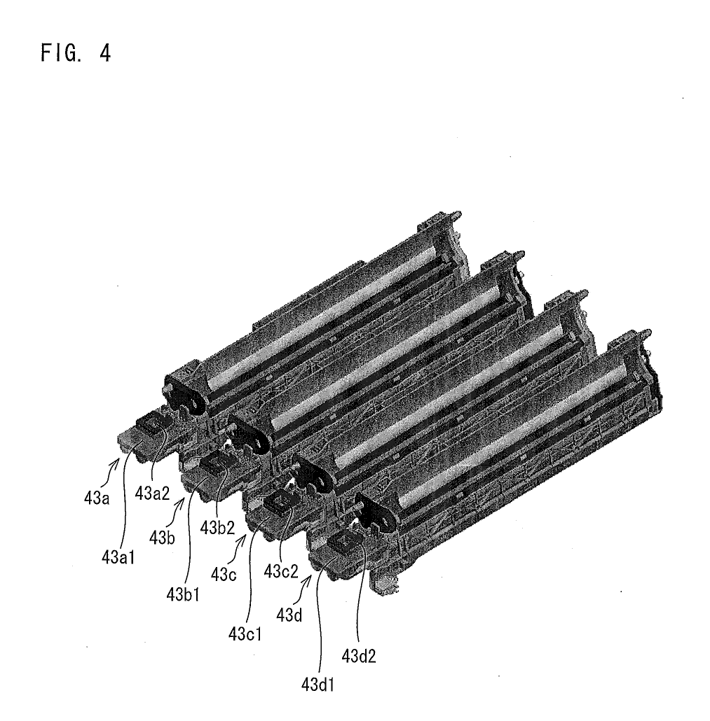

Inside the image forming apparatus 1, there are provided four developing devices 43a to 43d respectively corresponding to positions of the four toner cartridges 71 to 74. FIG. 4 is a perspective view of the developing devices 43a to 43d. The developing devices 43a to 43d respectively include (i) toner intake sections 43a1 to 43d1 extending forward and (ii) toner intake openings 43a2 to 43d2 being provided on upper sides of the toner intake sections 43a1 to 43d1 (see FIG. 4). These developing devices 43a to 43d are located under their corresponding toner cartridges 71 to 74, and receive the toner supplied from the toner cartridges 71 to 74, respectively.

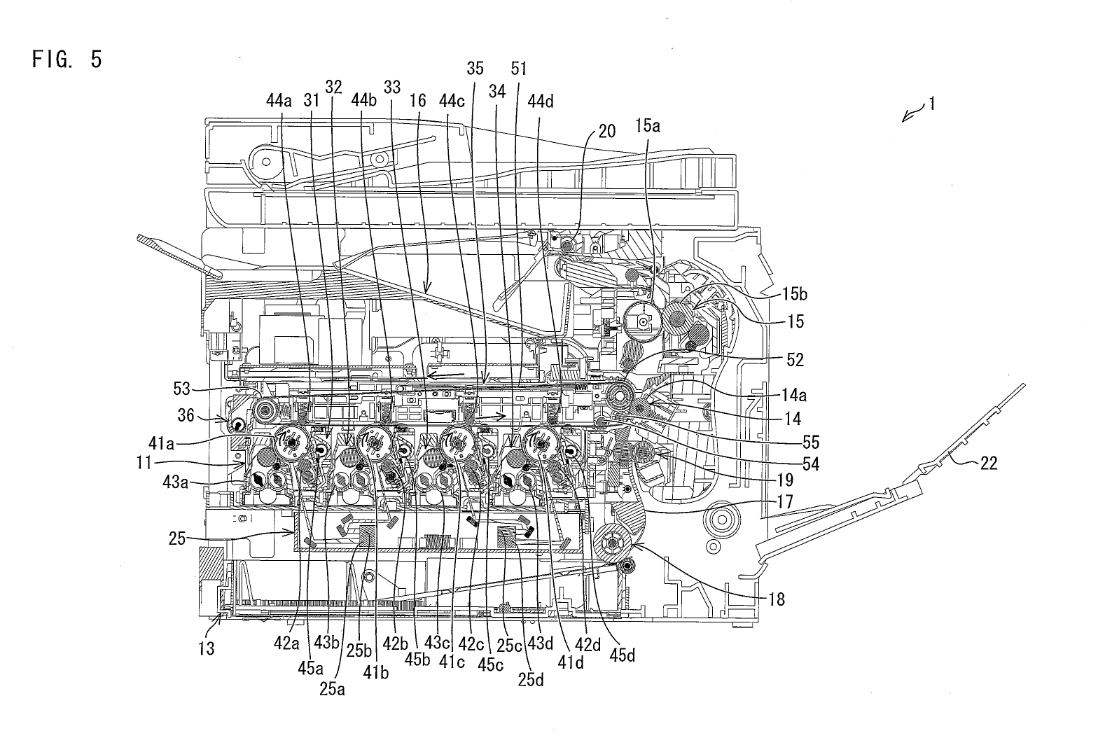

FIG. 5 is an elevational view illustrating an inner configuration of the image forming apparatus 1. The image forming apparatus 1 includes a process unit 11 provided on a lower side thereof (see FIG. 5). Below the process unit 11, there are provided a laser optical unit 25 and the paper feeding cassette 13 disposed in this order from the top. Further, there is provided a transfer section 14 on the right side (when seen in FIG. 5) of the process unit 11, and there is provided a fixing section 15 above the transfer section 14.

A pathway from the paper feeding cassette 13 to the paper output tray 16 includes a paper carrying path 17. The paper carrying path 17 is provided with a paper feeding roller 18, a timing roller 19, the transfer section 14, the fixing section 15, and a paper ejection roller 20 disposed in this order along a direction from the paper feeding cassette 13 to the paper output tray 16.

The process unit 11 includes first to fourth image forming sections 31 to 34, an intermediate transfer belt unit 35, and a transfer belt cleaning device 36. The first to fourth image forming sections 31 to 34 are provided for yellow toner, magenta toner, cyan toner, and black toner, respectively.

The first image forming section 31 includes a photoreceptor drum 41a, a charger 42a, the developing device 43a, an intermediate transfer roller 44a, and a photoreceptor cleaning unit 45a.

The charger 42a charges a surface of the photoreceptor drum 41a to a predetermined electric potential. The developing device 43a develops, with toner, an electrostatic latent image formed on the surface of the photoreceptor drum 41a as a result of exposure of the photoreceptor drum 41a to a laser beam emitted from the laser optical unit 25. The intermediate transfer roller 44a is provided on a back surface of an intermediate transfer belt 51 in the intermediate transfer belt unit 35, and transfers a toner image thus formed on the surface of the photoreceptor drum 41a by the development to a surface of the intermediate transfer belt 51. A photoreceptor cleaning device 45a removes and collects remaining toner and paper powder on the surface of the photoreceptor drum 41a after the development and the image transfer.

Similarly, the second image forming section 32 includes a photoreceptor drum 41b, a charger 42b, a developing device 43b, an intermediate transfer roller 44b, and a photoreceptor cleaning device 45b. The third image forming section 33 includes a photoreceptor drum 41c, a charger 42c, a developing device 43c, an intermediate transfer roller 44c, and a photoreceptor cleaning device 45c. The fourth image forming section 34 includes a photoreceptor drum 41d, a charger 42d, a developing device 43d, an intermediate transfer roller 44d, and a photoreceptor cleaning device 45d.

The intermediate transfer belt unit 35 includes the intermediate transfer belt 51, a driving roller 52 for supporting the intermediate transfer belt 51, a driven roller 53, and tension rollers 54 and 55. The transfer belt cleaning device 36 removes remaining toner and paper powder on the surface of the intermediate transfer belt 51.

The laser optical unit 25 includes laser sources 25a to 25d provided respectively for the photoreceptor drums 41a to 41d, and irradiates the photoreceptor drums 41a to 41d with laser beams emitted from the laser sources 25a to 25d so that an electrostatic latent image corresponding to an image to be printed by the image forming apparatus 1 is formed on surfaces of the photoreceptor drums 41a to 41d.

The transfer section 14 includes a transfer roller 14a which is pressed onto the driving roller 52 of the intermediate transfer belt unit 35 via the intermediate transfer belt 51, and transfers the toner image formed on the surface of the intermediate transfer belt 51 to a sheet fed from the paper feeding cassette 13. The fixing section 15 includes a fixing roller 15a and a pressure roller 15b by which the toner image on the sheet is melted so as to be fixed onto the sheet.

(Image Forming Operation)

The image forming apparatus 1 configured as described above prints a color image in the following manner. According to inputted image data, the laser optical unit 25 emits a laser beam onto the photoreceptor drums 41a to 41d, so that electrostatic latent images are formed on the photoreceptor drums 41a to 41d. The electrostatic latent images are developed with toner supplied from the developing devices 43a to 43d. Then, toner images colored in yellow, magenta, cyan, and black are formed on surfaces of the photoreceptor drums 41a to 41d, respectively.

These toner images are successively transferred onto the same position on the intermediate transfer belt 51 of the intermediate transfer belt unit 35 so as to overlap with each other, and a resulting image is further transferred onto a sheet by the transfer section 14. The sheet is fed from the paper feeding cassette 13 to the paper carrying path 17 by the paper feeding roller 18, and then is fed to the transfer section 14 by the timing roller 19 at a timing when the toner image on the intermediate transfer belt 51 is supplied to the transfer section 14.

The sheet onto which the toner image is transferred by the transfer section 14 is conveyed to the fixing section 15, so that the toner image is fixed onto the sheet by the fixing section 15. Then, the sheet is discharged onto the paper output tray 16 by the paper ejection roller 20.

(Toner Cartridge)

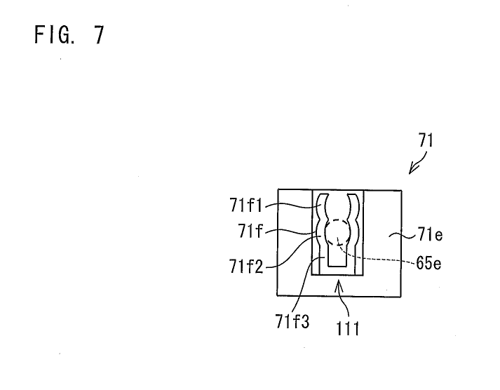

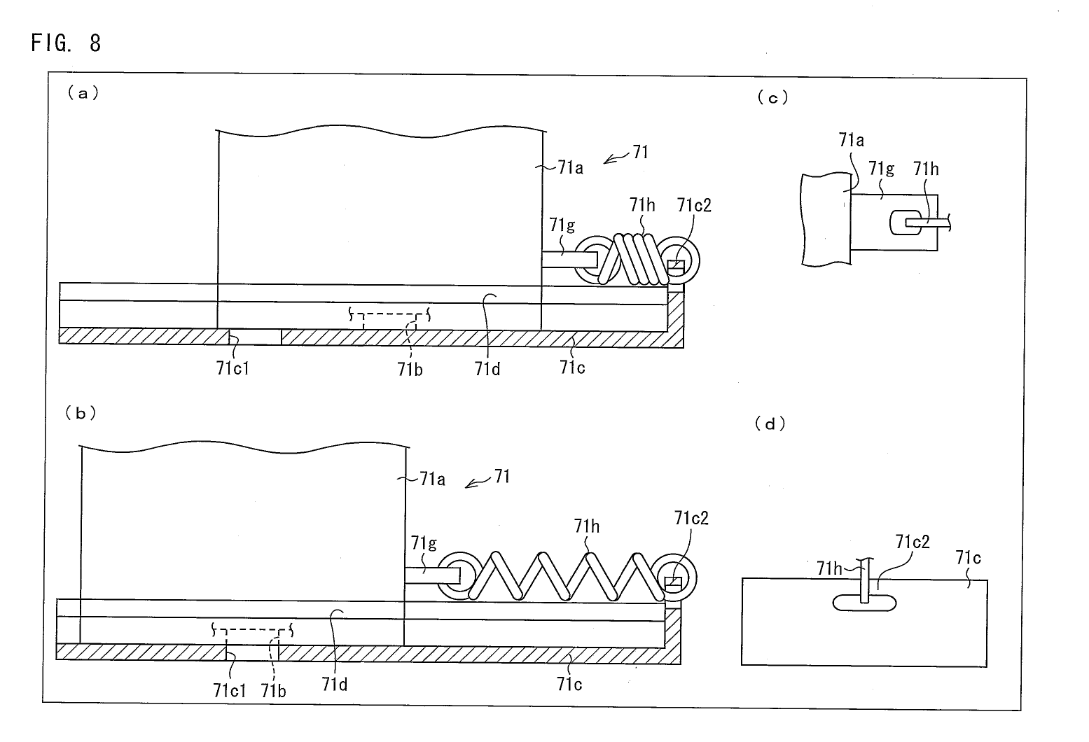

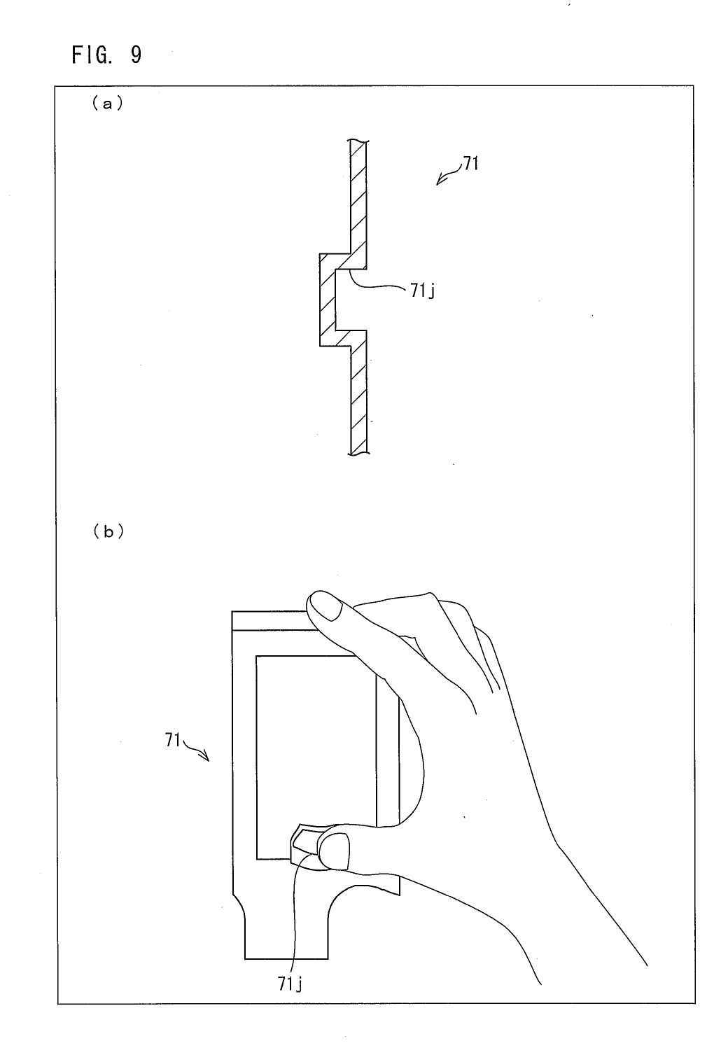

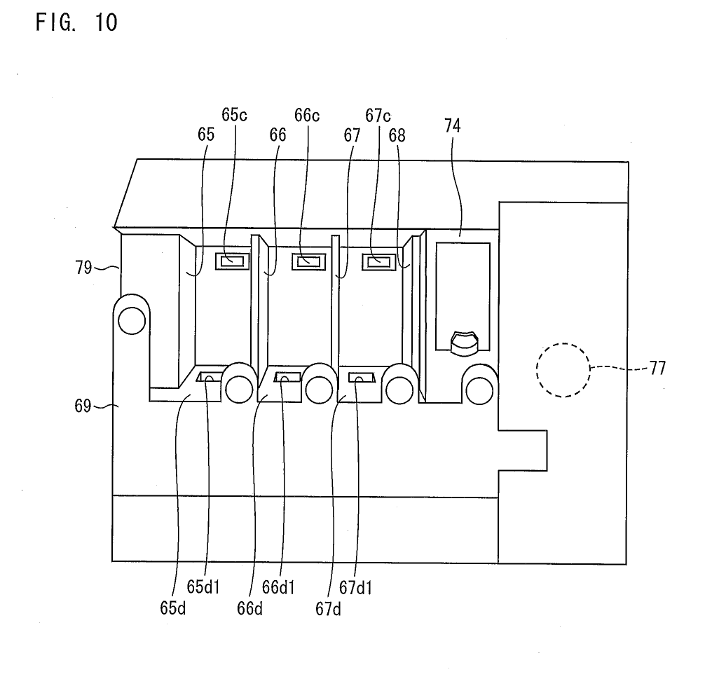

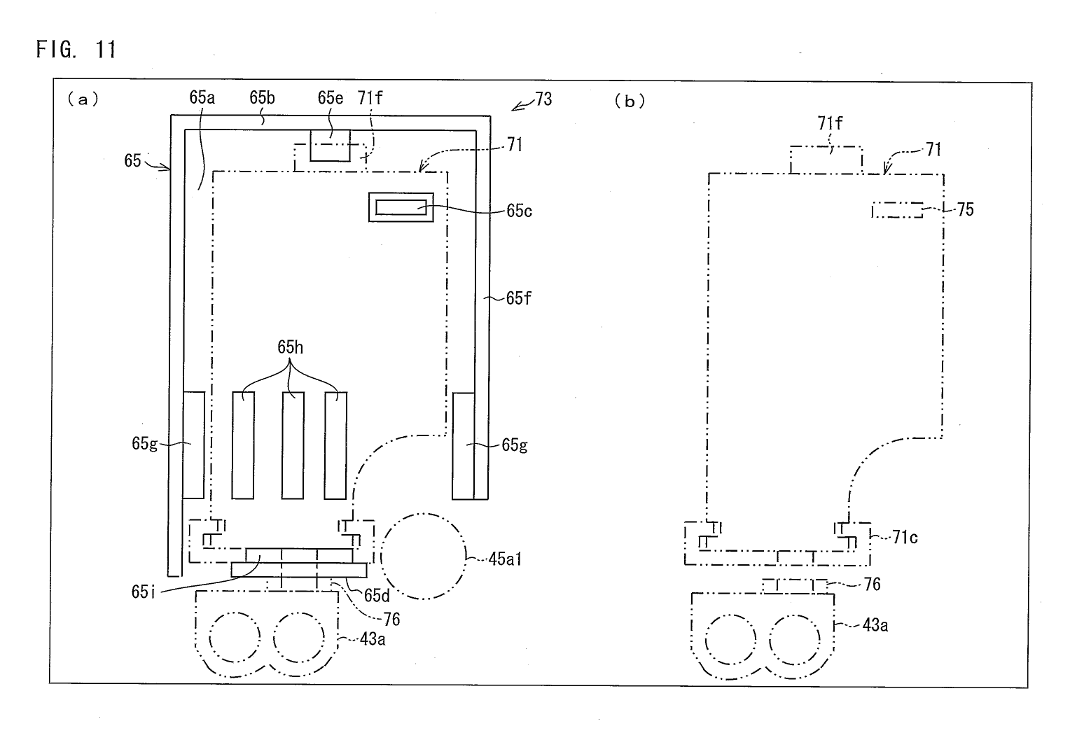

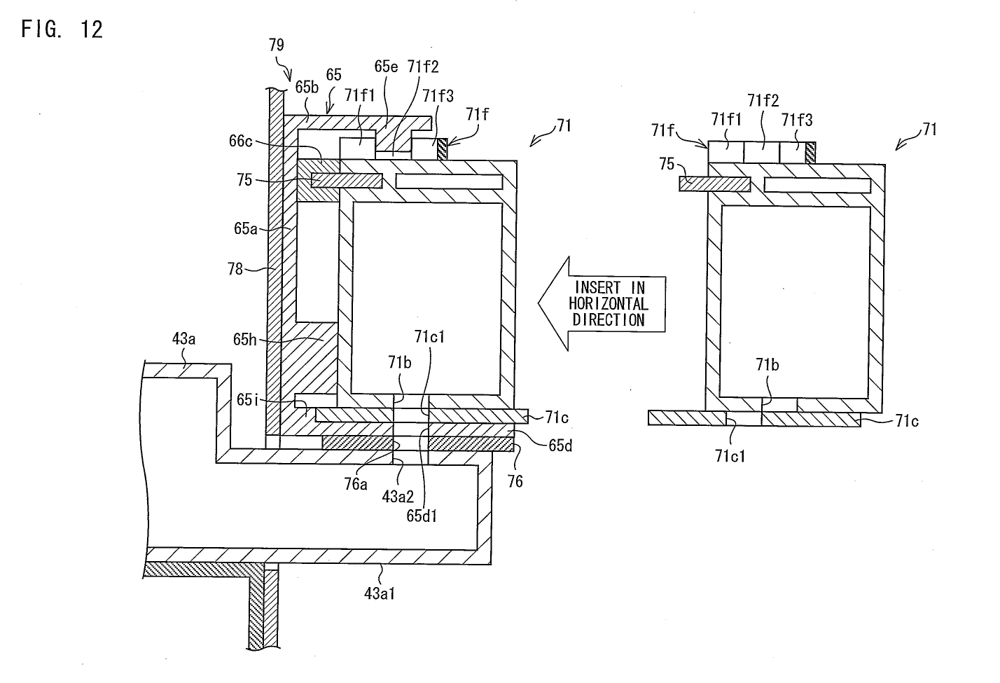

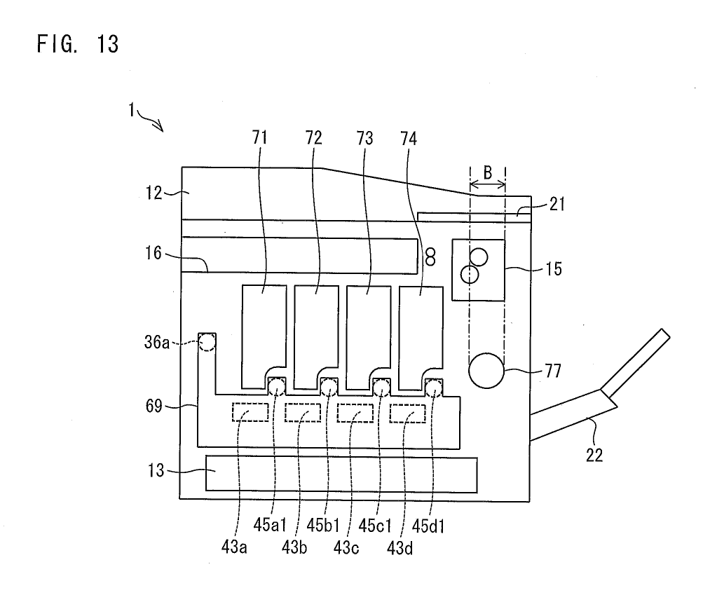

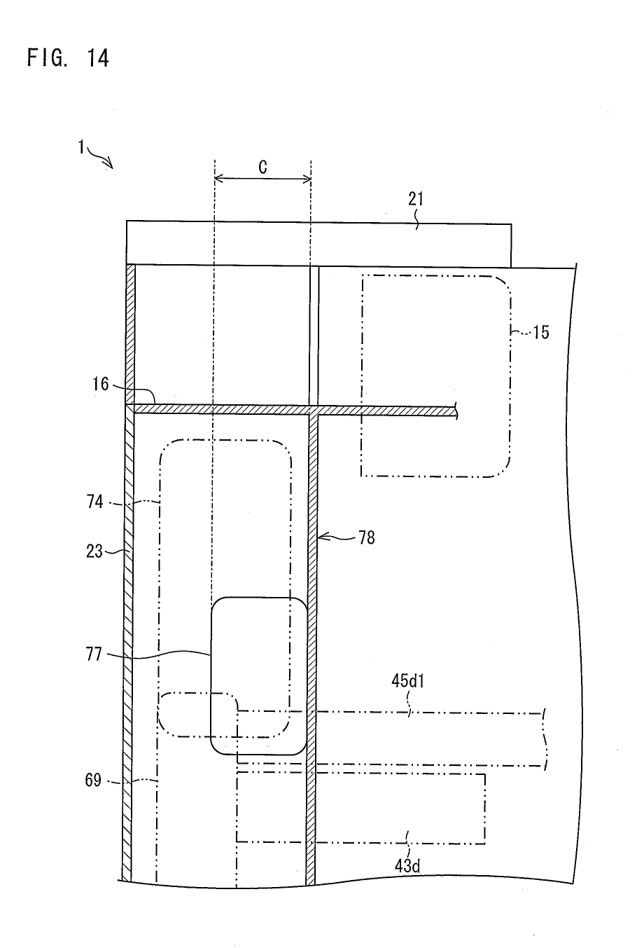

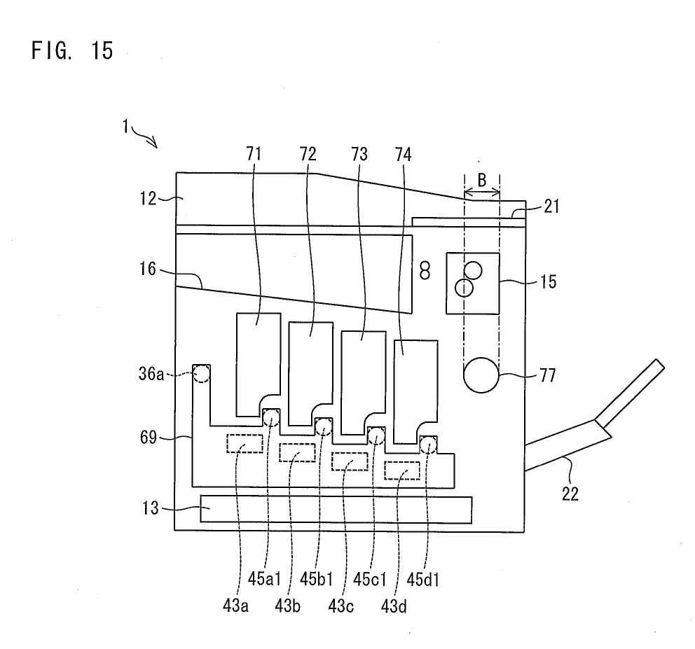

FIG. 6 is a perspective view of a toner cartridge 71. FIG. 7 is a plan view of the toner cartridge 71. Since the toner cartridges 71 to 74 have the same configuration and the cartridge attaching sections 65 to 68 have the same configuration, the toner cartridge 71 and the cartridge attaching section 65 will be explained as an example.

The toner cartridge 71 has a vertically long shape, and includes a toner storing section 71a for storing toner therein (see FIG. 6). The toner storing section 71a has a toner supply opening 71b located in a lower end of the toner storing section 71a. Further, the toner storing section 71a includes a shutter 71c for opening and closing the toner supply opening 71b. The toner storing section 71a has lateral sides facing each other, each of the lateral sides being provided with a shutter holding groove 71d which holds the shutter 71c and by which sliding of the shutter 71c is guided.

On the toner storing section 71a, a memory covering member 71e is provided. The memory covering member 71e has a surface facing the image forming device 1 and having a memory holding recess 71e1. The memory holding recess 71e1 holds an IC chip 75 including a non-volatile memory (CRUM).

The IC chip 75 stores, for example, main body information, history information, and recycle information which are related to the toner cartridges 71 to 74. The main body information is indicative of, e.g., a product number (proper information), a content, a color of toner stored, a lot number, a production date, a manufacturer, and an address and telephone number of the manufacturer, each relating to each of the toner cartridges 71 to 74. The history information is indicative of, e.g., a remaining amount of toner, a starting date of use, and hour(s) of actual use. The recycle information is indicative of, e.g., the number of times being recycled, a date of recycle, a collector, and an address and telephone number of the collector. The information stored in the IC chip 75 is read out by a control section (not illustrated) of the image forming apparatus 1, and is appropriately displayed on the display device included in the operation panel 21.

(a) of FIG. 8 shows a side view of the toner cartridge 71 and a longitudinal section view of the shutter 71c which is closed. (b) of FIG. 8 shows a side view of the toner cartridge 71 and a longitudinal section view of the shutter 71c which is opened. (c) of FIG. 8 is a plan view illustrating a spring connecting section 71g of the toner storing section 71a. (d) of FIG. 8 is an elevational view illustrating a spring connecting section 71c2 of the shutter 71c.

The toner cartridge 71 has a surface on which the spring connecting section 71g is provided, the surface being opposite to the surface facing the image forming apparatus 1 (see FIG. 8). Correspondingly, the shutter 71c has an edge on which the spring connecting section 71c2 is provided, the edge (hereinafter, referred to as a “rear edge”) facing the spring connecting section 71g. The spring connecting sections 71g and 71c2 are respectively connected with ends of a tension spring 71h which is made of a coil spring. Further, the shutter 71c has a portion facing the bottom of the toner storing section 71a and having a toner passing opening 71c1 (see (a) of FIG. 8).

In a state where the toner cartridge 71 is not attached to the cartridge attaching section 65, the shutter 71c is closed so that the toner supply opening 71b is covered (see (a) of FIG. 8). In contrast, in a state where the toner cartridge 71 is attached to the cartridge attaching section 65, the shutter 71c is opened so that the toner supply opening 71b and the toner passing opening 71c1 make a passage (see (b) of FIG. 8).

An upper surface of the toner cartridge 71, namely, an upper surface of the memory covering member 71e is provided with a fitted section 71f which protrudes upward (see FIGS. 6 and 7). The fitted section 71f and a fitting protrusion 65e of the cartridge attaching section 65 constitute a fixing mechanism 111.

The fitted section 71f has a fitting guiding section 71f1, a fitting holding section 71f2, and a U-shaped section 71f3, which are arranged in this order from (i) a first surface of the fitted section 71f facing the image forming apparatus 1 when the toner cartridge 71 is attached to the image forming apparatus 1 to (ii) a second surface of the fitted section 71f being opposite to the first surface.

The fitting guiding section 71f1 is constituted by two arc-shaped walls facing each other at a given space. The fitting holding section 71f2 is constituted by two arc-shaped walls which are connected to the arc-shaped walls of the fitting guiding section 71f1 and face each other at a space narrower than that of the fitting guiding section 71f1. The U-shaped section 71f3 is constituted by a U-shaped wall which is connected to the arc-shaped walls of the fitting holding section 71f2.

Therefore, in each of (i) a part where the fitting guiding section 71f1 and the fitting holding section 71f2 are connected to each other and (ii) a part where the fitting holding section 71f2 and the U-shaped section 71f3 are connected to each other, a space between the walls facing each other is narrower. Consequently, the fitted section 71f has constrictions at these parts. With this, when the toner cartridge 71 moves toward the image forming apparatus 1 so as to be attached thereto, the fitting protrusion 65e, which is to be fitted to the fitted section 71f (see FIG. 12), passes through the fitting guiding section 71f1 and then reaches the fitting holding section 71f2, so as to be accommodated and held by the fitting holding section 71f2.

Each of the walls constituting the fitting guiding section 71f1, the fitting holding section 71f2, and the U-shape section 71f3 has a thickness in a range of 1.0 mm to 2.0 mm, as well as that of a surrounding wall of the toner storing section 71a. The fitted section 71f is molded concurrently with the toner storing section 71a in a process for molding the toner cartridge 71 with a resin.

(a) of FIG. 9 is a longitudinal section view of a back wall of the toner cartridge 71 (a wall of the toner cartridge 71 being opposite to a wall of the toner cartridge 71 facing the cartridge attaching section 65). (b) of FIG. 9 is a view showing how to handle the toner cartridge 71 with use of a recess on the back wall.

The toner cartridge 71 has a recess 71j in a lower part of a back surface of the toner cartridge 71 (a surface of the toner cartridge 71 being opposite to a surface of the toner cartridge 71 facing the cartridge attaching section 65) (see (a) of FIG. 9). The recess 71j has a size enough to allow a thumb of a person to be inserted thereinto. Therefore, an operator can detach the toner cartridge 71 from the cartridge attaching section 65 by holding the toner cartridge 71 with his/her thumb inserted into the recess 71j and other fingers placed on the upper surface of the toner cartridge 71 (see (b) of FIG. 9).

(Cartridge Attaching Section)

FIG. 10 is an elevational view schematically illustrating a configuration of the cartridge attaching sections 65 to 68 of the image forming apparatus 1 and a part around the cartridge attaching sections 65 to 68. (a) of FIG. 11 is an elevational view of the cartridge attaching section 65. (b) of FIG. 11 is a view illustrating the toner cartridge 71 and the developing device 43a shown in (a) of FIG. 11. FIG. 12 shows longitudinal cross section views respectively illustrating (i) a state in which the toner cartridge 71 is not attached to the cartridge attaching section 65 and (ii) a state in which the toner cartridge 71 is attached to the cartridge attaching section 65. Note that FIG. 10 shows a state in which only the toner cartridge 74 is attached to the cartridge attaching section 68.

The cartridge attaching sections 65 to 68 are formed on a front surface of the front inside cover 79, and are separated from each other for their respective toner cartridges 71 to 74 (see FIG. 10). The front inside cover 79 is attached to, for example, a front frame 78 made from iron which is located on the front surface side of the image forming apparatus 1 (see FIG. 12).

The following description deals with the cartridge attaching section 65 and the toner cartridge 71 as an example. The cartridge attaching section 65 includes a cartridge facing section 65a facing the toner cartridge 71 and an upper wall part 65b which extends from a top edge of the cartridge facing section 65a orthogonally to the cartridge facing section 65a so as to cover the toner cartridge 71. The upper wall part 65b has a lower surface provided with the fitting protrusion 65e protruding downward.

The cartridge facing section 65a is provided with an IC chip fitting section (non-volatile memory attaching section) 65c being a recess to which the IC chip 75 is fitted when the toner cartridge 71 is attached to the cartridge attaching section 65. Note that FIG. 10 also shows IC chip fitting sections 66c and 67c respectively provided for cartridge attaching sections 66 and 67.

The cartridge section 65 includes, in its lower part, a lower cartridge guiding section 65d for guiding the toner cartridge 71 when the toner cartridge 71 is attached to the cartridge attaching section 65. Note that FIG. 10 also shows lower cartridge guiding sections 66d and 67d for their respective cartridge attaching sections 66 and 67.

The lower cartridge guiding section 65d has a toner passing opening 65d1 which allows passage of toner supplied via the toner supply opening 71b and the toner passing opening 71c1 of the toner cartridge 71. Note that FIG. 10 also shows lower cartridge guiding sections 66d1 and 67d1 for their respective cartridge attaching sections 66 and 67.

The cartridge attaching section 65 includes side walls 65f facing each other. On inner surfaces of the side walls 65f, side cartridge guiding sections 65g are formed. Further, the cartridge facing section 65a includes cartridge contacting sections 65h and a shutter stopping section 65i provided under the cartridge contacting sections 65h.

Around the toner intake opening 43a2 made on the toner intake section 43a1 of the developing device 43a, there is provided a toner leak-proof member 76 having a toner passing opening 76a and being made of, e.g., a sponge.

(Waste Toner Box)

FIG. 13 is an elevational view illustrating relative positions of the toner cartridges 71 to 74, the waste toner box 69, the operation panel 21, the fixing section 15, and a fixing drive motor 77 in the image forming apparatus 1.

The waste toner box 69 is shaped in, for example, a thin rectangular box, and stores waste toner and paper powder collected by the transfer belt cleaning device 36 and the photoreceptor cleaning devices 45a to 45d (see FIG. 13). For this purpose, the waste toner box 69 is connected with (i) a waste toner conveying pipe 36a connected to the transfer belt cleaning device 36 and (ii) waste toner conveying pipes 45a1 to 45d1 respectively connected to the photoreceptor cleaning devices 45a to 45d. Once the waste toner box 69 is filled with waste toner, the waste toner box 69 is replaced with an empty waste toner box. Note that the waste toner and/or the like is conveyed from the transfer belt cleaning device 36 and the photoreceptor cleaning devices 45a to 45d to the waste toner box 69 by, for example, waste toner conveying screws included in the transfer belt cleaning device 36 and the photoreceptor cleaning devices 45a to 45d.

(Relative Positions of Toner Cartridges, Waste Toner Box, Operation Panel, and Fixing Drive Motor)

FIG. 14 is a longitudinal section view of the image forming apparatus 1 illustrated in FIG. 13 seen from a side thereof.

The toner cartridges 71 to 74 and the waste toner box 69 are positioned between (i) the front frame 78 or the front inside cover 79 and (ii) the front door (front housing section) 23 (see FIGS. 12 to 14). The front frame 78 is a front side frame inside the image forming apparatus 1. The front inside cover 79 (see FIG. 12) is positioned between the front frame 78 and the front door (front housing section) 23.

The fixing drive motor 77 rotates the fixing roller 15a of the fixing section 15. The fixing drive motor 77 is provided so as to be close to the front surface of the image forming apparatus 1, to be laterally side-by-side to the toner cartridges 71 to 74 and the waste toner box 69 (to be at a right side of the toner cartridges 71 to 74 and the waste toner box 69 when the image forming apparatus 1 is seen from a front), and to be located below the operation panel 21. Namely, the fixing drive motor 77 is positioned in a front side part of an inside of the image forming apparatus 1 and laterally to the toner cartridges 71 to 74 and the waste toner box 69 in a direction parallel to an outer surface of the front door (front housing section) 23. The fixing drive motor 77 is located closely to the fixing section 15 in right and left directions of the image forming apparatus 1 and closely to the front surface of the front frame 78.

As for the relative positions of the operation panel 21 and the fixing drive motor 77, the fixing drive motor 77 is positioned in a region B overlapping, in a plan view of the image forming apparatus 1 in right and left directions, a region where the operation panel 21 exists (see FIG. 13). Furthermore, the fixing drive motor 77 is positioned in a region C overlapping, in a plan view of the image forming apparatus 1 in back and forth directions, a region where the operation panel 21 exists (see FIG. 14). That is, the operation panel 21 is positioned on the upper surface of the image forming apparatus 1 so as to be at least partially on a region right above the fixing drive motor 77.

In the configuration illustrated in FIG. 13, the toner cartridges 71 to 74 are positioned so as to be aligned in right and left directions at the same height. Alternatively, the toner cartridges 71 to 74 may be positioned in such a manner that a cartridge on the right side (when the image forming apparatus 1 is seen from a front) is positioned lower than a cartridge on the left side (when the image forming apparatus 1 is seen from a front). Such a configuration allows the paper output tray 16 having the same length as that of the paper output tray 16 illustrated in FIG. 13 to be positioned in an inclined manner. This allows the paper output tray 16 to have a larger capacity to receive an outputted recording paper and thereby makes it easier for a user to take out the outputted recording paper. Besides, such a configuration allows the image forming apparatus 1 to have a narrower width in the right and left directions of the image forming apparatus 1, thereby further downsizing an area where the image forming apparatus 1 is provided.

The following description deals with an example where the toner cartridge 71 is replaced with a new one in the configuration described above.

(Attachment of Toner Cartridge to Cartridge Attaching Section)

In order to attach the toner cartridge 71 to the cartridge attaching section 65, the front door 23 is opened, and then the toner cartridge 71 is pushed into the image forming apparatus 1 toward the cartridge attaching section 65. That is, the toner cartridge 71 is horizontally moved from the front surface to the back surface of the image forming apparatus 1.

During this, the toner cartridge 71 can be stably moved by being guided by the lower cartridge guiding section 65d and side cartridge guiding sections 65g of the cartridge attaching section 65.

Pushing the toner cartridge 71 toward the cartridge attaching section 65 causes a tip of the shutter 71c to come in contact with the shutter stopping section 65i (see FIG. 12). This does not allow the shutter 71c to move any more, thereby causing only the toner storing section 71a to move toward the cartridge attaching section 65.

Thereafter, a front surface of the toner storing section 71a comes in contact with the cartridge contacting sections 65h, so that the toner cartridge 71 is completely attached to the cartridge attaching section 65. In this state, the toner supply opening 71b of the toner storing section 71a, the toner passing opening 71c1 of the shutter 71c, the toner passing opening 65d1 of the lower cartridge guiding section 65d, the toner passing opening 76a of the toner leak-proof member 76, and the toner intake opening 43a2 on the toner intake section 43a1 of the developing device 43a are matched each other to make a passage (see FIG. 12). This allows supply of toner from the toner cartridge 71 to the developing device 43a.

In the case where the toner cartridge 71 is completely attached to the cartridge attaching section 65 as above, the fitting protrusion 65e of the cartridge attaching section 65 is fitted to the fitting holding section 71f2 in the fitted section 71f of the toner cartridge 71. Thus, the toner cartridge 71 which is completely attached to the cartridge attaching section 65 is firmly fixed to the cartridge attaching section 65 in such a manner that the toner cartridge 71 can communicate with the image forming apparatus 1.

Since the fitting protrusion 65e is fitted to the fitting holding section 71f2 by being guided by the fitting guiding section 71f1, the fitting protrusion 65e can be smoothly fitted to the fitting holding section 71f2. When the fitting protrusion 65e moves from the fitting guiding section 71f1 to the fitting holding section 71f2, the fitting protrusion 65e passes through the part having the narrower space between the fitting guiding section 71f1 and the fitting holding section 71f2.

Therefore, an operator can easily confirm, by feeling with his/her hand or finger, that the toner cartridge 71 is completely attached to the toner attaching section 65, from a change in force necessary to push the toner cartridge 71, namely, such a change from weak force (at the fitting guiding section 71f1) to strong force (at the part having the narrower space between the fitting guiding section 71f1 and the fitting holding section 71f2) and then to weak force (at the fitting holding section 71f2).

Furthermore, since the fitted section 71f includes the fitting guiding section 71f1 which works first and the fitting holding section 71f2 which works after the fitting guiding section 71f1, it is easy to visually check a process in which the fitting protrusion 65e is fitted to the fitting holding section 71f2. That is, an operator who handles the toner cartridge 71 first visually checks a state in which the fitting protrusion 65e is fitted to the fitting guiding section 71f1. With this, the operator can confirm that the toner cartridge 71 is on the way to be completely fitted to the cartridge attaching section 65. Then, the operator visually checks a state in which the fitting protrusion 65e is fitted to the fitting holding section 71f2. With this, the operator can confirm that the toner cartridge 71 has been completely attached firmly to the cartridge attaching section 65.

In the state where the toner cartridge 71 is completely attached to the cartridge attaching section 65, the IC chip 75 held by the memory holding recess 71e1 is fitted to the IC chip fitting section 65c. Thus, by a single action of pushing the toner cartridge 71 into the cartridge attaching section 65, it is possible to simultaneously carry out (i) attachment of the IC chip 75 to the IC chip fitting section 65c and (ii) fitting of the IC chip 75 to the IC chip fitting section 65c.

In the state in which the IC chip 75 is fitted to the IC chip fitting section 65c, as shown in FIG. 12, the IC chip 75 is completely covered with the IC chip fitting section 65c and the memory cover member 71e (see FIG. 6). Therefore, it is possible to prevent toner and dust floating in the image forming apparatus 1 from entering the IC chip fitting section 65c and the memory holding recess 71e1 (see FIG. 6), so as to avoid poor connection of the IC chip 75.

(Detachment of Toner Cartridge from Cartridge Attachment Section)

In order to replace the toner cartridge 71 with a new one, the front door 23 is opened and the toner cartridge 71 is detached from the cartridge attaching section 65. In this case, the above-described operation for attaching the toner cartridge 71 to the cartridge attaching section 65 is carried out reversely.

Specifically, an operator horizontally pulls the toner cartridge 71 toward the front surface of the image forming apparatus 1 by holding the toner cartridge 71 with his/her thumb inserted into the recess 71j of the toner cartridge 71 and other fingers placed on the upper surface of the toner cartridge 71 (see (b) of FIG. 9). This makes it possible to detach the toner cartridge 71 from the cartridge attaching section 65. At the same time, this also makes it possible to detach the IC chip 75 held by the memory holding recess 71e1 from the IC chip fitting section 65c.

During the detachment of the toner cartridge 71, the toner cartridge 71 can be stably moved by being guided by the lower cartridge guiding section 65d and the side cartridge guiding sections 65g of the cartridge attaching section 65.

Further, during the detachment of the toner cartridge 71, the movement of the toner cartridge 71 toward the front surface of the image forming apparatus 1 causes the tension spring 71h to pull and move the shutter 71c, so that the toner supply opening 71b is closed by the shutter 71c (see (a) of FIG. 8). This prevents toner leakage from the toner supply opening 71b.

### SUMMARY

The image forming apparatus 1 in accordance with first aspect of the present invention is an image forming apparatus 1, including: the toner cartridges 71 to 74; the waste toner box 69 for containing waste toner supplied from the toner cartridges 71 to 74 and thereafter collected; and the fixing drive motor 77 for driving the fixing device (fixing section 15), the toner cartridges 71 to 74 and the waste toner box 69 being positioned between (i) the front frame 78 or the front inside cover 79 of the image forming apparatus 1 and (ii) the front housing section (front door 23) of the image forming apparatus 1, the front frame 78 being a front side frame inside the image forming apparatus 1, and the front inside cover 79 being positioned between the front frame 78 and the front housing section, and the fixing drive motor 77 being positioned in a front side part of an inside of the image forming apparatus 1 and laterally to the toner cartridges 71 to 74 and the waste toner box 69 in a direction parallel to an outer surface of the front housing section.

With the arrangement, the fixing drive motor 77 is located at a normally empty region which is positioned in a front side part of inside the image forming apparatus 1 and laterally to the toner cartridges 71 to 74 and the waste toner box 69 in a direction parallel to the outer surface of the front housing section. This allows downsizing the image forming apparatus and reducing an area occupied by the image forming apparatus.

An image forming apparatus 1 in accordance with second aspect of the present invention may be an image forming apparatus according to the first aspect, further including the display device (operation panel 21), the display device being positioned on a top surface of the image forming apparatus 1 so as to be at least partially on a region right above the fixing drive motor 77.

With the arrangement, the display device is positioned on a top surface of the image forming apparatus 1 so as to be at least partially on a region right above the fixing drive motor 77. Accordingly, even if the display device is a large one, the display device hardly blocks attachment/detachment of the toner cartridges 71 to 74 and the waste toner box 69.

An image forming apparatus 1 in accordance with third aspect of the present invention may be an image forming apparatus according to the first aspect or the second aspect, further comprising the paper output tray 16 for receiving a printed paper, the paper output tray 16 being a part, above the toner cartridges 71 to 74, of a housing of the image forming apparatus 1 which housing covers the toner cartridges 71 to 74.

With the arrangement, the paper output tray 16 is a part, above the toner cartridges 71 to 74, of a housing of the image forming apparatus 1 which housing covers the toner cartridges 71 to 74. Consequently, the top surface of the housing of the image forming apparatus 1 can be used effectively. This allows the image forming apparatus 1 to have a more compact structure.

An image forming apparatus in accordance with fourth aspect of the present invention may be an image forming apparatus according to any one of the first aspect to the third aspect, further including the cartridge attaching sections 65 to 68 to which the toner cartridges 71 to 74 are detachably attached, respectively, respective attachment of the toner cartridges 71 to 74 to the cartridge attaching sections 65 to 68 being made by moving the toner cartridges 71 to 74 in a direction from a front surface to a back surface of the image forming apparatus 1, and respective detachment of the toner cartridges 71 to 74 to the cartridge attaching sections 65 to 68 being made by moving the toner cartridges 71 to 74 in a direction from the back surface to the front surface of the image forming apparatus 1.

With the arrangement, a user can easily attach the toner cartridges 71 to 74 to or detach the toner cartridges 71 to 74 from the image forming apparatus 1 while facing the front surface of the image forming apparatus 1.

An image forming apparatus 1 in accordance with fifth aspect of the present invention is an image forming apparatus according to the fourth aspect, wherein the toner cartridges 71 to 74 each include the non-volatile memory (IC chip 75), and the cartridge attaching sections 65 to 68 each include the non-volatile memory attaching section (IC chip fitting section 65c) to which the non-volatile memory is attached when the toner cartridges 71 to 74 are attached to the cartridge attaching sections 65 to 68, respectively, and from which the non-volatile memory is detached when the toner cartridges 71 to 74 are detached from the cartridge attaching sections 65 to 68, respectively.

With the arrangement, the non-volatile memory included in each of the toner cartridges 71 to 74 is attached to the non-volatile memory attaching section when the toner cartridges 71 to 74 are attached to the cartridge attaching sections 65 to 68, respectively, and the non-volatile memory is detached from the non-volatile memory attaching section when the toner cartridges 71 to 74 are detached from the cartridge attaching sections 65 to 68, respectively. Consequently, with a simple configuration, the non-volatile memory can be easily put in a communicable state in accordance with attachment of the toner cartridge.

The present invention is not limited to the description of the embodiments above, but may be altered by a skilled person within the scope of the claims. An embodiment based on a proper combination of technical means disclosed in different embodiments is encompassed in the technical scope of the present invention.

### REFERENCE SIGNS LIST

1 Image forming apparatus
12 Automatic document feeder
13 Paper feeding cassette
14 Transfer section
15 Fixing section
16 Paper output tray
21 Operation panel (Display device)
23 Front Door (Front housing section)
31 to 34 First to fourth image forming section
35 Intermediate transfer belt unit
36 Transfer belt cleaning device
36a Waste toner conveying pipe
41a to 41d Photoreceptor drum
43a to 43d Developing device
43a1 to 43d1 Toner intake section
43a2 to 43d2 Toner intake opening
45a to 45d Photo conductor cleaning device
45a1 to 45d1 Waste toner conveying pipe
65 to 68 Cartridge attaching section
65a Cartridge facing section
65c IC chip fitting section (Non-volatile memory attaching section)
65d Lower cartridge guiding section
65e Fitting protrusion
65g Cartridge guiding section
65h Cartridge contacting section
65i Shutter stopping section
69 Waste toner box
71 to 74 Toner cartridge
71a Toner storing section
71b Toner supply opening
71c Shutter
71c1 Toner passing opening
71h Tension spring
71e Memory covering member
75 IC chip
77 Fixing drive motor
78 Front frame
79 Front inside cover

1. An image forming apparatus, comprising:
a toner cartridge;
a waste toner box for containing waste toner after the waste toner is collected, the waste toner being remainder of toner supplied from the toner cartridge and used in the image forming apparatus; and
a fixing drive motor for driving a fixing device,
the toner cartridge and the waste toner box being positioned between (i) a front frame or a front inside cover of the image forming apparatus and (ii) a front housing section of the image forming apparatus, the front frame being a front side frame inside the image forming apparatus, and the front inside cover being positioned between the front frame and the front housing section, and
the fixing drive motor being positioned in a front side part of an inside of the image forming apparatus and laterally to the toner cartridge and the waste toner box in a direction parallel to an outer surface of the front housing section.

2. The image forming apparatus as set forth in claim 1, further comprising a display device,
the display device being positioned on a top surface of the image forming apparatus so as to be at least partially on a region right above the fixing drive motor.

3. The image forming apparatus as set forth in claim 1, further comprising a paper output tray for receiving a printed paper, the paper output tray being a part, above the toner cartridge, of a housing of the image forming apparatus which housing covers the toner cartridge.

4. The image forming apparatus as set forth in claim 1, further comprising a cartridge attaching section to which the toner cartridge is detachably attached,
attachment of the toner cartridge to the cartridge attaching section being made by moving the toner cartridge in a direction from a front surface to a back surface of the image forming apparatus, and detachment of the toner cartridge from the cartridge attaching section being made by moving the toner cartridge in a direction from the back surface to the front surface of the image forming apparatus.

5. The image forming apparatus as set forth in claim 4, wherein
the toner cartridge includes a non-volatile memory, and
the cartridge attaching section includes a non-volatile memory attaching section to which the non-volatile memory is attached when the toner cartridge is attached to the cartridge attaching section, and from which the non-volatile memory is detached when the toner cartridge is detached from the cartridge attaching section.
